(19) United States
(12) Patent Application Publication
(10) Pub. No.: US 2026/0256152 A1
(43) Pub. Date: Sep. 3, 2026

(54) SMALL GAME CLEANING DEVICE

(71) Applicants: Marilyn Kritzman, Kalamazoo, MI (US); Anthony Tate, Grand Rapids, MI (US)

(72) Inventors: Marilyn Kritzman, Kalamazoo, MI (US); Anthony Tate, Grand Rapids, MI (US)

(21) Appl. No.: 19/067,337

(22) Filed: Feb. 28, 2025

(51) Int. Cl. A22B 5/00; A22C 17/02

(52) U.S. Cl. CPC A22B 5/0005; A22C 17/02

(57) ABSTRACT

A small game cleaning device includes a tray which has a perimeter wall that defines a game area of the tray. Small game can be positioned in a prone position in the game area to assist the user with gutting and cleaning the small game. The tray has a neck slot to accommodate a neck of the small game when the small game is laid in the game area. A plurality of first straps is each removably attachable to the perimeter wall and a plurality of second straps is each removably attachable to the perimeter wall of the tray. Each first strap and second strap can be extended over the small game when the small game is positioned in the game area. Additionally, each first strap is releasably matable to a respective one of the second straps to secure the small game in the game area of the tray.

### (b) Cross-reference to Related Applications

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention.

The disclosure relates to gutting and cleaning devices and more particularly pertains to a new gutting and cleaning device for securing small game for gutting and gutting and cleaning the small game. The device includes a tray that defines a game area into which small game can be placed in a prone position and a neck slot integrated into the track which accommodates a neck of the small game and a drain integrated into the tray for draining bodily fluids from the small game. The device includes a plurality of first straps which are each removably attached to the tray and a plurality of second straps which are each removably attached to the tray. Each of the first straps and second straps are extendable across the small game and each first strap is releasably matable to a respective second strap to secure the small game on the tray.

### (2) Description of Related Art including Information Disclosed Under 37 CFR 1.97 and 1.98.

The prior art relates to gutting and cleaning devices including: a boat mountable fish tray device which includes a tray extending between a pair of legs and a drainage opening in the tray and a cutting board that is attachable to the tray; a bait cutting board device which includes a cutting board with a cut-out to accommodate a cleat on a boat and a barrier extending around the cutting board; a portable cleaning table device that includes a cutting board and a support frame that has an upright stanchion to engage a tree to mount the cutting board to the tree; a fish cleaning device that includes a cutting board that has a slanted cleaning surface and a perimeter wall extending around the cutting board and a stanchion which is slidably attached to the cutting board and a mount that is attached to the stanchion for mounting to a surface; a cutting board device that includes a cutting board that has a perimeter wall and a belt attached to the cutting board which is extendable around a stanchion to mount the cutting board to the stanchion. In no instance does the prior art disclose a small game cleaning device that includes a tray that has a basal wall and a perimeter wall and a neck slot extending into the perimeter wall which accommodates a neck of a small game animal that is placed in a prone position on the tray and a drain extending through the basal wall to drain bodily fluids from the small game animal and a plurality of belts that are attached to the tray which are extendable over the small game animal to secure the small game animal for gutting and cleaning.

### (h) BRIEF SUMMARY OF THE INVENTION

An embodiment of the disclosure meets the needs presented above by generally comprising a tray which has a perimeter wall that defines a game area of the tray. Small game can be positioned in a prone position in the game area to assist the user with gutting and cleaning the small game. The tray has a neck slot to accommodate a neck of the small game when the small game is laid in the game area. A plurality of first straps is each removably attachable to the perimeter wall and a plurality of second straps is each removably attachable to the perimeter wall of the tray. Each first strap and second strap can be extended over the small game when the small game is positioned in the game area. Additionally, each first strap is releasably matable to a respective one of the second straps to secure the small game in the game area of the tray.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a small game cleaning device according to an embodiment of the disclosure.

FIG. 2 is an exploded perspective view of an embodiment of the disclosure.

FIG. 3 is a front view of an embodiment of the disclosure.

FIG. 4 is a left side view of an embodiment of the disclosure.

FIG. 5 is a top view of an embodiment of the disclosure.

FIG. 6 is a bottom view of an embodiment of the disclosure.

FIG. 7 is a perspective in-use view of an embodiment of the disclosure.

### (J) DETAILED DESCRIPTION OF THE INVENTION

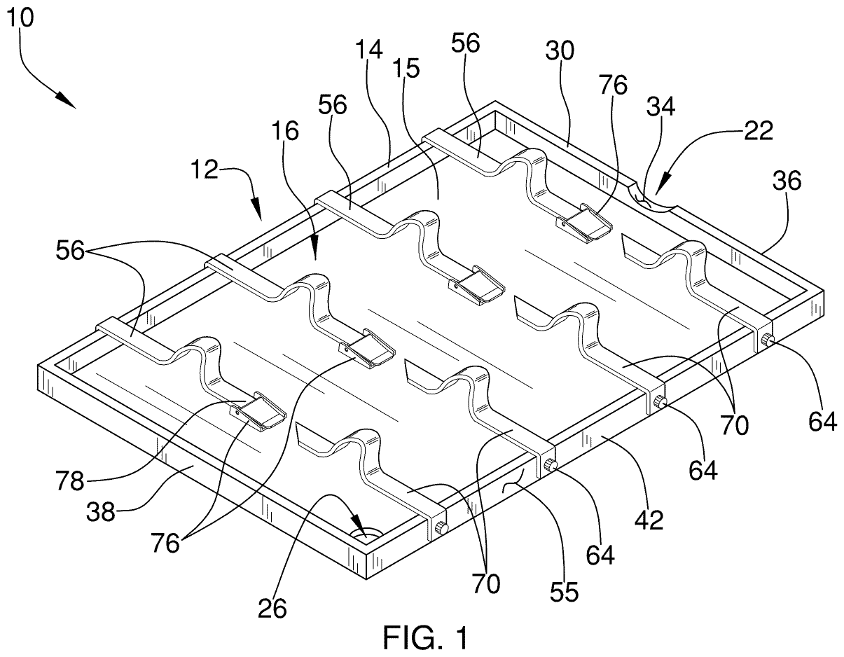

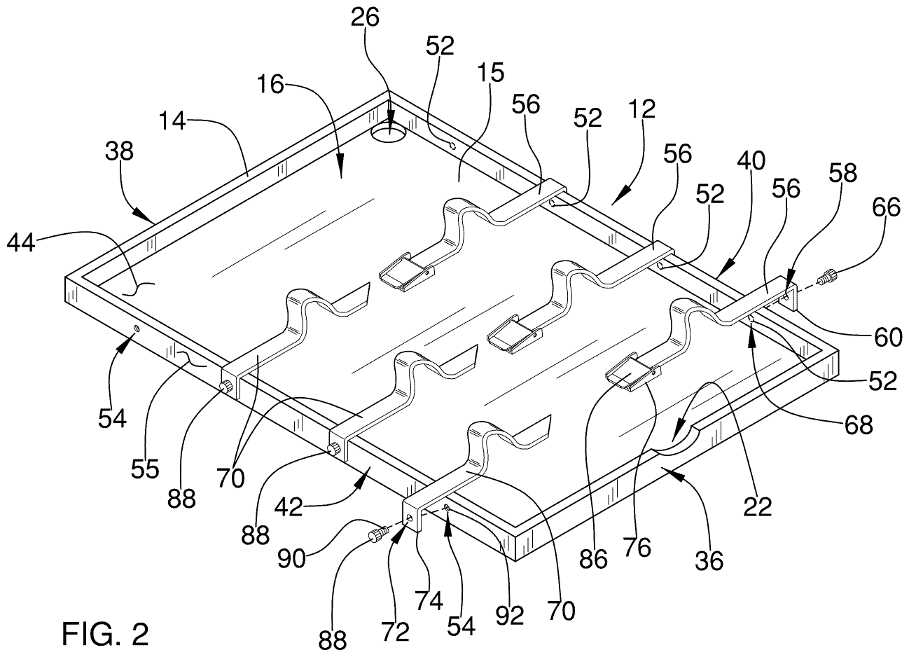

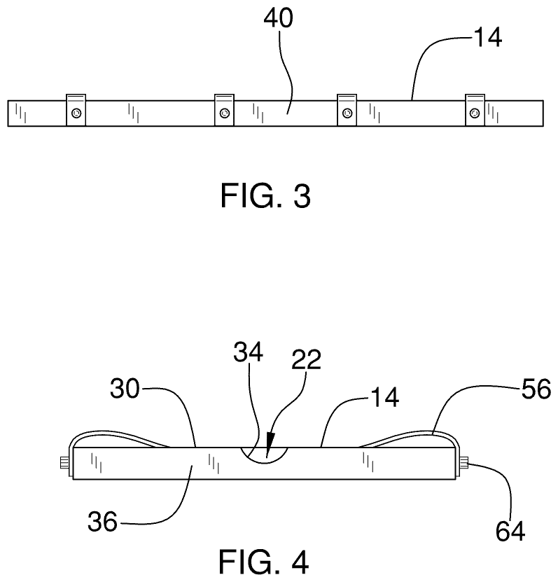

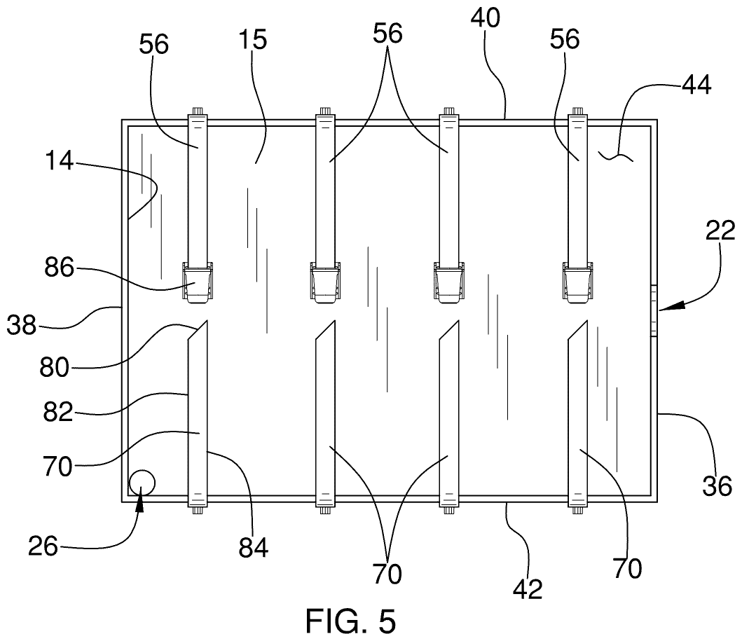

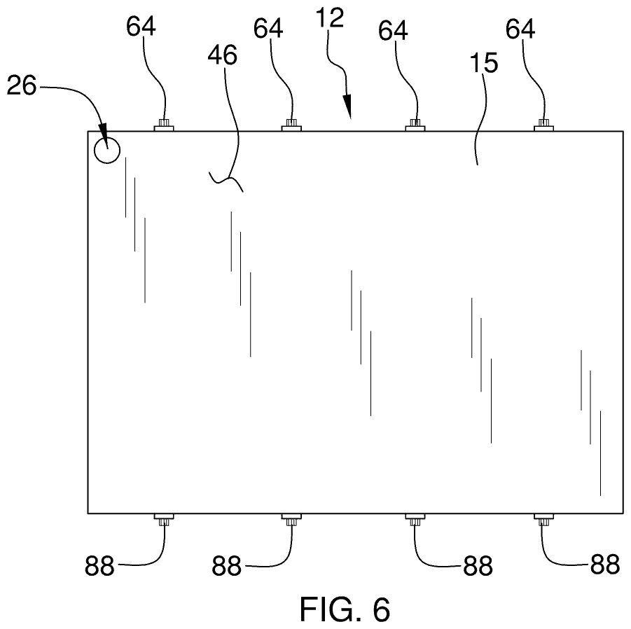

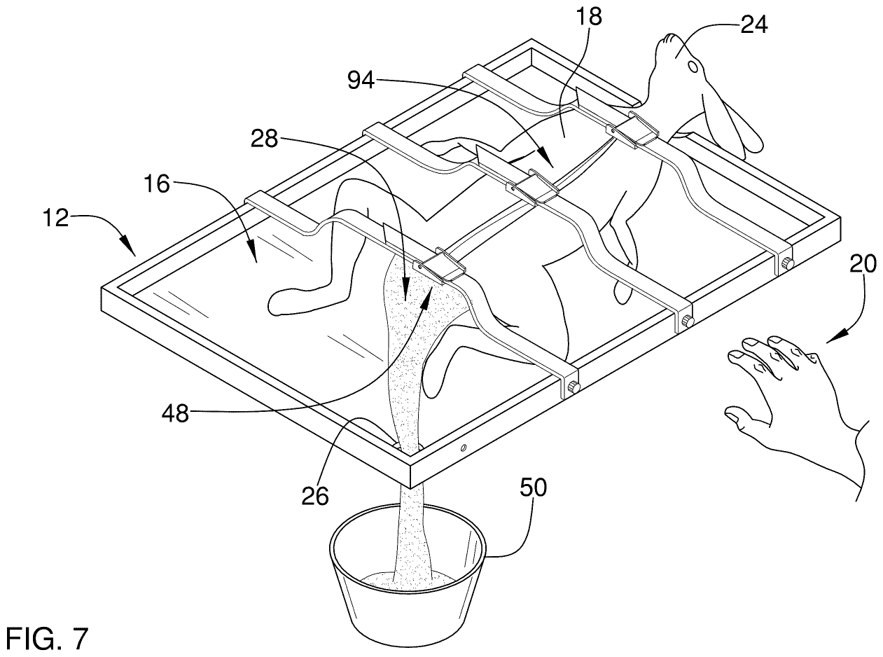

With reference now to the drawings, and in particular to FIGS. 1 through 7 thereof, a new gutting and cleaning device embodying the principles and concepts of an embodiment of the disclosure and generally designated by the reference numeral 10 will be described.

As best illustrated in FIGS. 1 through 7, the small game cleaning device 10 generally comprises a tray 12 that has a perimeter wall 14 extending upwardly from a basal wall 15 of the tray 12 which defines a game area 16 of the tray 12. Small game 18, such as a rabbit or a duck or other type of small game 18 which is hunted for eating, can be positioned in a prone position in the game area 16 to assist a user 20 with gutting and cleaning the small game 18. The tray 12 has a neck slot 22 that is integrated into the perimeter wall 14 to accommodate a neck 24 of the small game 18 when the small game 18 is laid in the game area 16. Additionally, a drain 26 is integrated into the basal wall 15 of the tray 12 to pass bodily fluids 28 from the small game 18 through the drain 26 when the small game 18 is being butchered in the game area 16 of the tray 12.

The neck slot 22 extends from a top edge 30 of the perimeter wall 14 toward the basal wall 15 of the tray 12. Furthermore, the neck slot 22 has a bounding surface 34 which is concavely arcuate with respect to the top edge 30 to conform to the shape of the neck 24 of the small game 18 when the neck 24 of the small game 18 is laid in the neck slot 22. The neck slot 22 is positioned on a primary side 36 of the perimeter wall 14 which is oriented parallel to a secondary side 38 of the perimeter wall 14 to accommodate the neck 24 of the small game 18 when the small game 18 is laid in the game area 16 to extend between the primary side 36 and the secondary side 38 of the perimeter wall 14. Furthermore, the neck slot 22 is centrally located between a first lateral side 40 and a second lateral side 42 of the perimeter wall 14 such that the neck slot 22 is aligned with the neck 24 of the small game 18 when the small game 18 is laid in the game area 16. Each of the first lateral side 40 and the second lateral side 42 are oriented perpendicular to the primary side 36 and the secondary side 38.

The drain 26 extends through a top surface 44 and a bottom surface 46 of the basal wall 15 to pass the bodily fluids 28 of the small game 18 through the basal wall 15. The drain 26 is aligned with an intersection between the secondary side 38 of the perimeter wall 14 and the second lateral side 42 of the perimeter wall 14 to inhibit the bodily fluids 28 of the small game 18 from collecting near an anus 48 of the small game 18. Subsequently, as is shown in FIG. 7, the bodily fluids 28 of the small game 18 can be collected in a container 50, such as a bucket for example, which is positioned beneath the drain 26. The drain 26 may have a diameter of at least 5.0 cm such that the drain is sufficiently large to pass guts of the small game animal 18 through the basal wall 15 for collection in the container 50.

A plurality of first holes 52 each extends into an outwardly facing surface 53 of the first lateral side 40 of the perimeter wall 14. The plurality of first holes 52 is evenly spaced apart from each other and is distributed between the primary side 36 and the secondary side 38 of the perimeter wall 14. None of the plurality of first holes 52 is in fluid communication with the game area 16 to inhibit the bodily fluids 28 from passing through any of the first holes 52. A plurality of second holes 54 each extends into an outwardly facing surface 55 of the second lateral side 42 of the perimeter wall 14. The plurality of second holes 54 is evenly spaced apart from each other and is distributed between the primary side 36 and the secondary side 38 of the perimeter wall 14. None of the plurality of second holes 54 is in fluid communication with the game area 16 to inhibit the bodily fluids 28 from passing through any of the second holes 54.

A plurality of first straps 56 is each removably attachable to the perimeter wall 14 of the tray 12. Each first strap 56 of the plurality of first straps 56 is extendable across the game area 16 of the tray 12 to be extended over the small game 18 when the small game 18 is positioned in the game area 16. Additionally, each first strap 56 of the plurality of first straps 56 has an opening 58 which is spaced from a first end 60 of a respective first strap 56. The opening in the respective first strap 56 is aligned with a respective one of the plurality of first holes 52 in the first lateral side 40 of the perimeter wall 14 of the tray 12.

A plurality of first screws 64 is provided and each first screw 64 of the plurality of first screws 64 is extendable through the opening 58 in a respective one of the plurality of first straps 56 and a respective one of the plurality of first holes 52 in the first lateral side 40 of the perimeter wall 14 of the tray 12. Each first screw 64 of the plurality of first screws 64 has a threaded shaft 66 which threadably engages a bounding surface 68 of the respective first hole 52 for releasably attaching the respective first strap 56 to the first lateral side 40 of the perimeter wall 14 of the tray 12.

A plurality of second straps 70 is each removably attachable to the perimeter wall 14 of the tray 12. Each second strap 70 of the plurality of second straps 70 is extendable across the game area 16 of the tray 12 to be extended over the small game 18 when the small game 18 is positioned in the game area 16. Furthermore, each first strap 56 of the plurality of first straps 56 is releasably matable to a respective one of the plurality of second straps 70 to secure the small game 18 in the game area 16 of the tray 12. Each second strap 70 of the plurality of second straps 70 has an opening 72 which is spaced from a first end 74 of a respective second strap 70. The opening 72 in the respective second strap 70 is aligned with a respective one of the plurality of second holes 54 in the second lateral side 42 of the perimeter wall 14 of the tray 12.

A plurality of buckles 76 is provided and each buckle 76 of the plurality of buckles 76 is attached to a second end 78 of a respective one of the plurality of first straps 56. Each buckle 76 of the plurality of buckles 76 insertably receives a second end 80 of a respective one of the plurality of second straps 70. Additionally, the second end 80 of each second strap 70 is cut at a sloping angle between a first lateral edge 82 and a second lateral edge 84 of the second straps 70 to assist with extending the second end 80 of each second strap 70 into the respective buckle 76. Each buckle 76 of the plurality of buckles 76 has a closure 86 that is positionable in a closing position to compress the respective second strap 70 for retaining the respective second strap 70 in a respective buckle 76. Conversely, the closure 86 of each buckle 76 of the plurality of buckles 76 is positionable in an open position to disengage from the respective second strap 70 for releasing the respective second strap 70 from the respective buckle 76.

A plurality of second screws 88 is provided and each second screw 88 of the plurality of second screws 88 is extendable through the opening 72 in a respective one of the plurality of second straps 70 and a respective one of the plurality of second holes 54 in the second lateral side 42 of the perimeter wall 14 of the tray 12. Each second screw 88 of the plurality of second screws 88 has a threaded shaft 90 which threadably engages a bounding surface 92 of the respective second hole 54 for releasably attaching the respective second strap 70 to the second lateral side 42 of the perimeter wall 14 of the tray 12.

In use, the small game 18 is laid with its belly 94 facing upwardly in the game area 16 of the tray 12 and the neck 24 of the small game 18 is positioned in the neck slot 22. Each of the first straps 56 and each of the second straps 70 are extended across the small game 18 and each of the first straps 56 is secured in the respective buckle 76 to secure the small game 18 on the tray 12. The small game 18 is gutted and cleaned on the tray 12 and the drain 26 enables the bodily fluids 28 to drain 26 from the tray 12 during the process of gutting and cleaning the small game 18. Additionally, the container 50 is positioned beneath the drain 26 to collect the bodily fluids 28 for subsequent disposal. One or more of the first screws 64 and the second screws 88 can be removed from the perimeter wall 14 of the tray 12 to subsequently remove a respective first strap 56 and second strap 70 from the perimeter wall 14 if the small game 18 is not large enough to require all of the first straps 56 and the second straps 70 for securing the small game 18 in the game area 16 of the tray 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A small game cleaning device for securing small game in a prone position to assist a user with gutting and cleaning the small game, said device comprising:
a tray having a perimeter wall extending upwardly from a basal wall, said perimeter wall defining a game area of said tray wherein said game area is configured to have small game positioned in a prone position in said game area to assist the user with gutting and cleaning the small game, said tray having a neck slot being integrated into said perimeter wall wherein said neck slot is configured to accommodate a neck of the small game when the small game is laid in said game area, said tray having a drain being integrated into said basal wall wherein said drain is configured to pass bodily fluids from the small game through said drain when the small game is being butchered in said game area of said tray;
a plurality of first straps, each first strap of said plurality of first straps being removably attachable to said perimeter wall of said tray, each first strap of said plurality of first straps being extendable across said game area of said tray wherein each first strap of said plurality of first straps is configured to be extended over the small game when the small game is positioned in said game area; and
a plurality of second straps, each second strap of said plurality of second straps being removably attachable to said perimeter wall of said tray, each second strap of said plurality of second straps being extendable across said game area of said tray wherein each second strap of said plurality of second straps is configured to be extended over the small game when the small game is positioned in said game area, each first strap of said plurality of first straps being releasably matable to a respective one of said plurality of second straps wherein said plurality of first straps and said plurality of second straps is configured to secure the small game in the game area of said tray.

2. The small game cleaning device according to claim 1, wherein:
said neck slot extends from a top edge of said perimeter wall toward said basal wall of said tray; and
said neck slot has a bounding surface being concavely arcuate with respect to said top edge wherein said bounding surface is configured to conform to the shape of the neck of the small game when the neck of the small game is laid in said neck slot.

3. The small game cleaning device according to claim 1, wherein said neck slot is positioned on a primary side of said perimeter wall which is oriented parallel to a secondary side of said perimeter wall wherein said neck slot is configured to accommodate the neck of the small game when the small game is laid in said game area extending between said primary side and said secondary side of said perimeter wall.

4. The small game cleaning device according to claim 1, wherein said neck slot is centrally located between a first lateral side and a second lateral side of said perimeter wall wherein said neck slot is configured to be aligned with the neck of the small game when the small game is laid in said game area.

5. The small game cleaning device according to claim 1, wherein said drain extends through a top surface and a bottom surface of said basal wall wherein said drain is configured to pass the bodily fluids of the small game through said basal wall.

6. The small game cleaning device according to claim 1, wherein:
said perimeter wall has a secondary side and a first lateral side and a second lateral side; and
said drain is aligned with an intersection between said secondary side of said perimeter wall and said second lateral side of said perimeter wall wherein said drain is configured to inhibit the bodily fluids of the small game from collecting near an anus of the small game.

7. The small game cleaning device according to claim 1, further comprising a plurality of first holes, each first hole of said plurality of first holes extending through an outwardly facing surface of a first lateral side of said perimeter wall, said plurality of first holes being evenly spaced apart from each other and being distributed between a primary side and a secondary side of said perimeter wall.

8. The small game cleaning device according to claim 7, further comprising a plurality of second holes, each second hole of said plurality of second holes extending into an outwardly facing surface of a second lateral side of said perimeter wall, said plurality of second holes being evenly spaced apart from each other and being distributed between said primary side and said secondary side of said perimeter wall.

9. The small game cleaning device according to claim 7, wherein:
each first strap of said plurality of first straps has an opening being spaced from a first end of a respective first strap; and
said opening in said respective first strap is aligned with a respective one of said plurality of first holes in said first lateral side of said perimeter wall of said tray.

10. The small game cleaning device according to claim 9, further comprising a plurality of first screws, each first screw of said plurality of first screws being extendable through said opening in a respective one of said plurality of first straps and a respective one of said plurality of first holes in said first lateral side of said perimeter wall of said tray.

11. The small game cleaning device according to claim 10, wherein each first screw of said plurality of first screws has a threaded shaft which threadably engages a bounding surface of said respective first hole for releasably attaching said respective first strap to said first lateral side of said perimeter wall of said tray.

12. The small game cleaning device according to claim 8, wherein:
each second strap of said plurality of second straps has an opening being spaced from a first end of a respective second strap; and
said opening in said respective second strap is aligned with a respective one of said plurality of second holes in said second lateral side of said perimeter wall of said tray.

13. The small game cleaning device according to claim 9, wherein each second strap of said plurality of second straps has a second end being cut at a sloping angle between a first lateral edge and a second lateral edge of said second straps.

14. The small game cleaning device according to claim 1, wherein:
each first strap of said plurality of first straps has a first end and a second end;
each second strap of said plurality of second straps has a first end and a second end;
said device includes a plurality of buckles;
each buckle of said plurality of buckles is attached to said second end of a respective one of said plurality of first straps; and
each buckle of said plurality of buckles insertably receives said second end of a respective one of said plurality of second straps.

15. The small game cleaning device according to claim 14, wherein each buckle of said plurality of buckles has a closure being positionable in a closing position to compress said respective second strap for retaining said respective second strap in a respective buckle.

16. The small game cleaning device according to claim 14, wherein said closure of each buckle of said plurality of buckles is positionable in an open position to disengage from said respective second strap for releasing said respective second strap from said respective buckle.

17. The small game cleaning device according to claim 13, further comprising a plurality of second screws, each second screw of said plurality of second screws being extendable through said opening in a respective one of said plurality of second straps and a respective one of said plurality of second holes in said second lateral side of said perimeter wall of said tray.

18. The small game cleaning device according to claim 17, wherein each second screw of said plurality of second screws has a threaded shaft which threadably engages a bounding surface of said respective second hole for releasably attaching said respective second strap to said second lateral side of said perimeter wall of said tray.

19. A small game cleaning device for securing small game in a prone position to assist a user with gutting and cleaning the small game, said device comprising:
a tray having a perimeter wall extending upwardly from a basal wall, said perimeter wall defining a game area of said tray wherein said game area is configured to have small game positioned in a prone position in said game area to assist the user with gutting and cleaning the small game, said tray having a neck slot being integrated into said perimeter wall wherein said neck slot is configured to accommodate a neck of the small game when the small game is laid in said game area, said tray having a drain being integrated into said tray wherein said drain is configured to pass bodily fluids from the small game through said drain when the small game is being butchered in said game area of said tray, said neck slot extending from a top edge of said perimeter wall toward a basal wall of said tray, said neck slot having a bounding surface being concavely arcuate with respect to said top edge wherein said bounding surface is configured to conform to the shape of the neck of the small game when the neck of the small game is laid in said neck slot, said neck slot being positioned on a primary side of said perimeter wall which is oriented parallel to a secondary side of said perimeter wall wherein said neck slot is configured to accommodate the neck of the small game when the small game is laid in said game area to extend between said primary side and said secondary side of said perimeter wall, said neck slot being centrally located between a first lateral side and a second lateral side of said perimeter wall wherein said neck slot is configured to be aligned with the neck of the small game when the small game is laid in said game area, each of said first lateral side and said second lateral side being oriented perpendicular to said primary side and said secondary side, said drain extending through a top surface and a bottom surface of said basal wall wherein said drain is configured to pass the bodily fluids of the small game through said basal wall, said drain being aligned with an intersection between a secondary side of said perimeter wall and said second lateral side of said perimeter wall wherein said drain is configured to inhibit the bodily fluids of the small game from collecting near an anus of the small game;
a plurality of first holes, each first hole of said plurality of first holes extending through said first lateral side of said perimeter wall, said plurality of first holes being evenly spaced apart from each other and being distributed between said primary side and said secondary side of said perimeter wall;
a plurality of second holes, each second hole of said plurality of second holes extending through said second lateral side of said perimeter wall, said plurality of second holes being evenly spaced apart from each other and being distributed between said primary side and said secondary side of said perimeter wall;
a plurality of first straps, each first strap of said plurality of first straps being removably attachable to said perimeter wall of said tray, each first strap of said plurality of first straps being extendable across said game area of said tray wherein each first strap of said plurality of first straps is configured to be extended over the small game when the small game is positioned in said game area, each first strap of said plurality of first straps having an opening being spaced from a first end of a respective first strap, said opening in said respective first strap being aligned with a respective one of said plurality of first holes in said first lateral side of said perimeter wall of said tray;
a plurality of first screws, each first screw of said plurality of first screws being extendable through said opening in a respective one of said plurality of first straps and a respective one of said plurality of first holes in said first lateral side of said perimeter wall of said tray, each first screw of said plurality of first screws having a threaded shaft which threadably engages a bounding surface of said respective first hole for releasably attaching said respective first strap to said first lateral side of said perimeter wall of said tray;
a plurality of second straps, each second strap of said plurality of second straps being removably attachable to said perimeter wall of said tray, each second strap of said plurality of second straps being extendable across said game area of said tray wherein each second strap of said plurality of second straps is configured to be extended over the small game when the small game is positioned in said game area, each first strap of said plurality of first straps being releasably matable to a respective one of said plurality of second straps wherein said plurality of first straps and said plurality of second straps is configured to secure the small game in the game area of said tray, each second strap of said plurality of second straps having an opening being spaced from a first end of a respective second strap, said opening in said respective second strap being aligned with a respective one of said plurality of second holes in said second lateral side of said perimeter wall of said tray, each second strap of said plurality of second straps having a second end being cut at a sloping angle between a first lateral edge and a second lateral edge of said second straps;
a plurality of buckles, each buckle of said plurality of buckles being attached to a second end of a respective one of said plurality of first straps, each buckle of said plurality of buckles insertably receiving said second end of a respective one of said plurality of second straps, each buckle of said plurality of buckles having a closure being positionable in a closing position to compress said respective second strap for retaining said respective second strap in a respective buckle, said closure of each buckle of said plurality of buckles being positionable in an open position to disengage from said respective second strap for releasing said respective second strap from said respective buckle; and
a plurality of second screws, each second screw of said plurality of second screws being extendable through said opening in a respective one of said plurality of second straps and a respective one of said plurality of second holes in said second lateral side of said perimeter wall of said tray, each second screw of said plurality of second screws having a threaded shaft which threadably engages a bounding surface of said respective second hole for releasably attaching said respective second strap to said second lateral side of said perimeter wall of said tray.
